(19) United States
(12) Patent Application Publication
(10) Pub. No.: US 2018/0037165 A1
(43) Pub. Date: Feb. 8, 2018

(54) IMAGE PROCESSING DEVICE AND ELECTRONIC MIRROR SYSTEM

(71) Applicant: Panasonic Intellectual Property Management Co., Ltd., Osaka (JP)

(72) Inventors: TERUMITSU SUENAGA, Osaka (JP); TAKASHI OKOHIRA, Kanagawa (JP); MOTONOBU UCHIMURA, Kanagawa (JP)

(21) Appl. No.: 15/549,664

(22) PCT Filed: Mar. 14, 2016
(86) PCT No.: PCT/JP2016/001423

§ 371 Date: Aug. 9, 2017

(30) Foreign Application Priority Data
Mar. 31, 2015 (JP) 2015-073528

(51) Int. Cl. B60R 1/12; G06T 11/60; H04N 5/232; B60R 1/04

(52) U.S. Cl. CPC B60R 1/12; B60R 1/04; G06T 11/60; H04N 5/23296; B60R 2300/301; B60R 2300/306

(57) ABSTRACT

An object sensor senses that an object has come near the vehicle by sensing that the object is within a predetermined range behind a vehicle. When the object sensor senses that the object has come near the vehicle by sensing that the object is within the predetermined range behind the vehicle, a compressor creates a compressed image obtained by compressing a part of a display target range in a rearward image. When the object having come near is sensed, the display target range is changed to a second display target range obtained by moving down a lower end of a first display target range; the first display target range is the display target range when the object is out of the predetermined range. The compressor compresses a part of the rearward image in a vertical direction; the rearward image is present within the second display target range.

### TECHNICAL FIELD

The present invention relates to an image processing device and an electronic mirror system, which are provided in a vehicle.

### BACKGROUND ART

In recent years, there has been a vehicle provided with a device, which captures an image behind the vehicle and displays the captured image so that a following vehicle or the like can be confirmed.

PTL 1 discloses, as an example of such a device as described above, a rear confirmation device which, when an opening/closing storage-type rear seat display provided on a ceiling of a vehicle is in an open state, prevents a part of the rear seat display from being reflected on an inside rear-view mirror provided in a front portion of the vehicle.

In this rear confirmation device, a magic mirror is used for a mirror surface of the inside rear-view mirror, and a liquid crystal display that displays a rearward image captured by a camera is disposed on a back surface of the magic mirror. Then, when the rear seat display is opened at an angle at which it is partially reflected on the inside rear-view mirror, the rearward image captured by the camera disposed on a rear end portion of a vehicle cabin is displayed on the liquid crystal display, and the rearward image is made visible through the magic mirror.

### CITATION LIST

### Patent Literature

PTL 1: Japanese Patent No. 3985333

### SUMMARY OF THE INVENTION

It is an object of the present invention to provide an image processing device and an electronic mirror system, which make it easy for a driver to grasp a sense of distance, and present more information to the driver who confirms the rear, thus making it possible to contribute to safe driving.

An image processing device of the present invention is an image processing device that performs image processing on a rearward image of a vehicle and outputs an image to a display; the rearward image is captured by an imaging unit; the image is obtained as a result of the image processing. The image processing device includes an object sensor and a compressor. The object sensor senses that an object has come near the vehicle by sensing that the object is within a predetermined range behind the vehicle. When the object sensor senses that the object has come near the vehicle by sensing that the object is within the predetermined range behind the vehicle, the compressor creates a compressed image obtained by compressing a part of a display target range in the rearward image. When the object having come near is sensed, the display target range is changed to a second display target range obtained by moving down a lower end of a first display target range; the first display target range is the display target range when the object is out of the predetermined range. The compressor compresses a part of the rearward image in a vertical direction; the rearward image is present within the second display target range.

An image processing device of the present invention includes the image processing device, the display, the imaging unit, and a distance measuring sensor that outputs a signal indicating a distance between the vehicle and the object; the object sensor senses that the object has come near the vehicle by sensing that the object is within the predetermined range behind the vehicle based on the signal output from the distance measuring sensor.

In accordance with the present invention, it is made easy for the driver to grasp the sense of distance, and more information is presented to the driver who confirms the rear, and thus a contribution can be made to the safe driving.

### BRIEF DESCRIPTION OF DRAWINGS

FIG. 1 is a diagram showing an example of a vehicle on which an electronic mirror system according to a first exemplary embodiment of the present invention is mounted.

FIG. 2 is a diagram showing an example of a configuration of an image display device shown in FIG. 1.

FIG. 3 is a block diagram showing an example of a functional configuration of an image processing device according to the first exemplary embodiment of the present invention.

FIG. 4 is a diagram for illustrating determination processing of a distance by an object sensor shown in FIG. 3.

FIG. 5 is a diagram showing an example of a first display target range.

FIG. 6 is a diagram showing an example of image processing performed on a rearward image captured by an imaging unit.

FIG. 7 is a diagram showing an example of a display image obtained as a result of the image processing.

FIG. 8 is a flowchart showing an example of a processing procedure of image processing according to the first exemplary embodiment of the present invention.

FIG. 9 is a block diagram showing an example of a functional configuration of an image processing device according to a second exemplary embodiment of the present invention.

FIG. 10 is a flowchart showing an example of a processing procedure of image processing according to the second exemplary embodiment of the present invention.

FIG. 11 is a diagram showing an example of image processing performed on a rearward image captured by an imaging unit.

FIG. 12 is a diagram showing an example of the display image obtained as a result of the image processing.

FIG. 13 is a flowchart showing an example of a processing procedure of image processing according to a third exemplary embodiment of the present invention.

FIG. 14 is a flowchart showing an example of a processing procedure of image processing according to a fourth exemplary embodiment of the present invention.

### DESCRIPTION OF EMBODIMENTS

Prior to describing exemplary embodiments of the present invention, problems found in a conventional device will now briefly be described herein. In the above-mentioned conventional technology of PTL 1, the camera is installed at the rear end of the vehicle cabin away from the inside rear-view mirror, and accordingly, a following vehicle is displayed largely when an image captured by the camera is simply displayed on the liquid crystal display, and the driver may sometimes feel that it is difficult to grasp the sense of distance.

Moreover, when the following vehicle approaches a subject vehicle too closely, then a direction indicator of the following vehicle becomes unseeable. It is also desired that this problem be solved, and that more information be presented to the driver so that the driver can drive more safely.

Hereinafter, exemplary embodiments of the present invention will be described in detail with reference to the drawings. Note that the respective exemplary embodiments, which will be described below, are merely examples, and the present invention is not limited by these exemplary embodiments.

### First Exemplary Embodiment

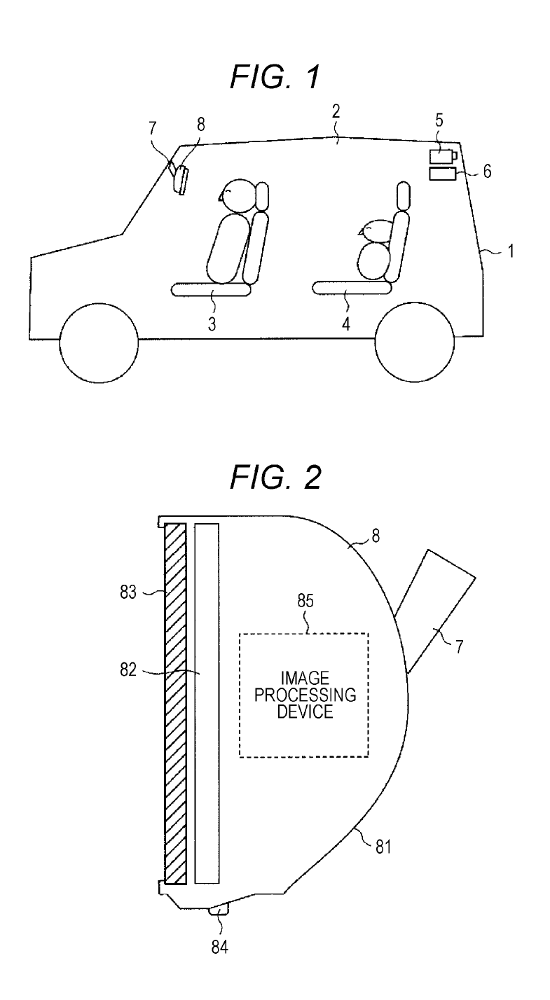

FIG. 1 is a diagram showing an example of vehicle 1 on which an electronic mirror system according to the first exemplary embodiment is mounted. Front seat (a driver's seat and a passenger's seat) 3 is disposed in a front portion of inside 2 of vehicle 1, and rear seat 4 is disposed in a rear portion of inside 2.

Moreover, installed on the rear of rear seat 4 are: imaging unit 5 which captures an image of the rear of vehicle 1; and distance measuring sensor 6, which detects a distance from vehicle 1 to an object such as a following vehicle that approaches the rear of vehicle 1, and outputs a signal indicating the distance. Note that, in the following description, it is assumed that the object that approaches the rear of vehicle 1 is the following vehicle.

Moreover, at an attaching position of an inside rear-view mirror in front of front seat 3, image display device 8 is attached to attachment portion 7 so that an attachment angle of image display device 8 can be adjustable. Image display device 8 is a device which displays a rearward image of vehicle 1 or the like, which is captured by imaging unit 5. Note that image display device 8 performs wired communication or wireless communication with imaging unit 5 and distance measuring sensor 6. Image display device 8, imaging unit 5 and distance measuring sensor 6 constitute an electronic mirror system.

FIG. 2 is a diagram showing an example of a configuration of image display device 8 shown in FIG. 1. As shown in FIG. 2, image display device 8 includes: main body case 81 having an opening on a front seat 3 side; display 82 such as a liquid crystal display housed in main body case 81 so that a display surface of display 82 can be directed to the front seat 3 side; light control filter 83 provided on the front seat 3 side of display 82; operating portion 84 which turns display 82 to an ON state or an OFF state; and image processing device 85.

Light control filter 83 is a device which can variably control its transmittance and reflectance by applying a voltage, and is capable of realizing at least two states which are a light reflection state and a light transmission state. Such a light control filter is described in detail, for example, in Unexamined Japanese Patent Publication No. 2012-181389.

When display 82 is turned to the OFF state by an operation of operating portion 84, image display device 8 brings light control filter 83 into a light reflection state with a reflectance of 50% or more (preferably a reflectance of 80% or more). In this state, light control filter 83 plays a role as a mirror. In this way, a driver can confirm the rear by an image reflected on light control filter 83.

Meanwhile, when display 82 is turned to the ON state by an operation of operating portion 84, image display device 8 brings light control filter 83 into a light transmission state with a transmittance of 50% or more (preferably a transmittance of 80% or more). In this state, light control filter 83 transmits an image displayed on display 82. At this time, the driver can confirm the rear by a rearward image of vehicle 1 displayed on display 82.

Note that a half mirror may be used in place of light control filter 83. When display 82 is in the ON state, the driver can confirm the rearward image, which is displayed on display 82, through the half mirror. Meanwhile, when display 82 is in the OFF state, the driver can confirm the rear by an image reflected on the half mirror. Moreover, the present invention may be applied to an electronic mirror system in which neither the light control filter nor the half mirror is provided and display 82 is always set to the ON state at the time of confirming the rear.

Image processing device 85 is a device which performs image processing on the rearward image of vehicle 1 captured by imaging unit 5, and outputs an image obtained as a result of the image processing to display 82. Next, a description will be made of an example of a configuration of this image processing device 85.

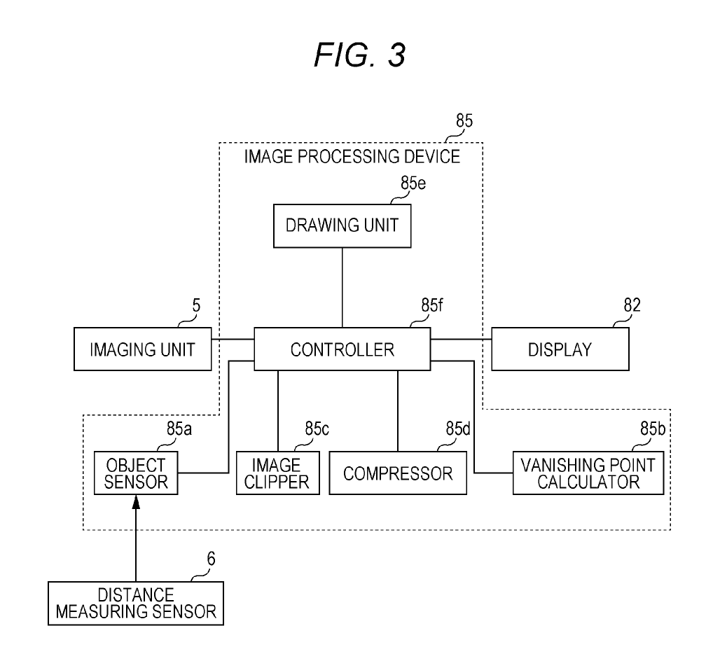

FIG. 3 is a block diagram showing an example of a functional configuration of image processing device 85 according to the first exemplary embodiment. Image processing device 85 is realizable, for example, as an LSI (Large Scale Integration) circuit or as a part of an electronic control unit (ECU) which controls vehicle 1.

Image processing device 85 includes object sensor 85a, vanishing point calculator 85b, image clipper 85c, compressor 85d, drawing unit 85e, and controller 85f.

Based on a signal which indicates a detection result of the distance and is output from distance measuring sensor 6, object sensor 85a senses that the following vehicle has come near vehicle 1 by sensing that the following vehicle is within a predetermined range behind vehicle 1.

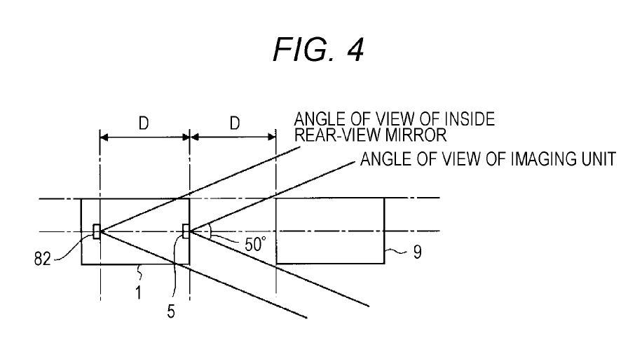

FIG. 4 is a diagram for illustrating determination processing for the distance by object sensor 85a shown in FIG. 3. For example, the above-mentioned predetermined range is a range where a distance from a rear end of vehicle 1 is within a distance corresponding to horizontal distance D from the rear end of vehicle 1 to a mounting position of display 82. Note that the predetermined range is not limited to this, and may be set arbitrarily.

When following vehicle 9 approaches vehicle 1 and a distance between vehicle 1 and following vehicle 9 becomes shorter than D, then following vehicle 9 will not remain within a capturing range (an angle of view is 50° in an example of FIG. 4) of imaging unit 5, and the image displayed on display 82 will largely differ from the image reflected on light control filter 83 which functions as a mirror. Therefore, it becomes difficult for the driver to grasp the sense of distance from following vehicle 9.

In order to solve such a problem, image processing device 85 performs predetermined image processing for the rearward image of vehicle 1 which is captured by imaging unit 5.

Note that, though distance measuring sensor 6 is installed at a position of imaging unit 5 in FIG. 1, distance measuring sensor 6 may be installed at another position. When distance measuring sensor 6 is installed at the other position, object sensor 85a is adjusted so that the distance between vehicle 1 and following vehicle 9 can be detected appropriately in response to the position where distance measuring sensor 6 is installed.

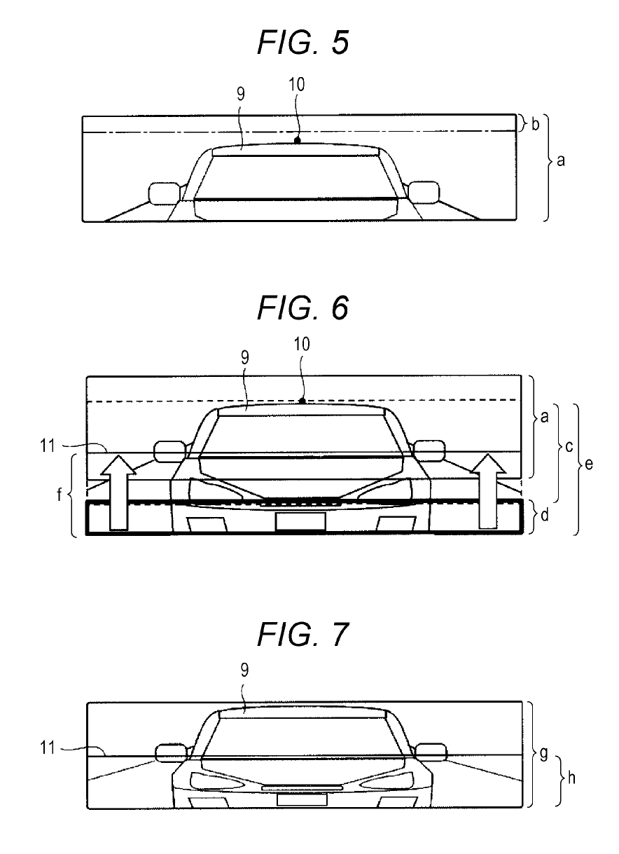

Hereinafter, vanishing point calculator 85b, image clipper 85c, compressor 85d and drawing unit 85e will be described with reference to FIGS. 5 to 7.

FIG. 5 is a diagram showing an example of first display target range a. FIG. 6 is a diagram showing an example of the image processing performed on the rearward image captured by imaging unit 5. FIG. 7 is a diagram showing an example of a display image obtained as a result of the image processing.

Vanishing point calculator 85b shown in FIG. 3 calculates a position of vanishing point 10 (refer to FIG. 5) of the image captured by imaging unit 5. Note that such calculation of vanishing point 10 in the image can be determined by using a conventional technology that uses an optical flow, a boundary line of a road, an outside line of a roadway, and the like.

Image clipper 85c clips a part of the rearward image captured by imaging unit 5, and creates a clipped image. The rearward image captured by imaging unit 5 includes an image of a wider range than first display target range a shown in FIG. 5. Therefore, image clipper 85c performs processing such as clipping of the image so that the image will remain within first display target range a.

Moreover, when it is sensed by object sensor 85a that following vehicle 9 has come near vehicle 1 by sensing that following vehicle 9 is within the predetermined range behind vehicle 1, image clipper 85c determines whether or not vanishing point 10 is located below predetermined range b in an upper portion of a display target range when following vehicle 9 is out of the predetermined range (first display target range a shown in FIG. 5).

A vertical length of predetermined range b is set, for example, to ⅕ of a vertical length of first display target range a. In this case, if a resolution of display 82 is 900 pixels in width and 250 pixels in height, then the vertical length of predetermined range b has a length corresponding to 50 pixels. Note that this length may be set arbitrarily.

When vanishing point 10 is located below predetermined range b (in the example shown in FIG. 5), then from the rearward image captured by imaging unit 5, image clipper 85c clips an image of a display target range obtained by moving down an upper end and lower end of first display target range a (a range obtained by combining range c and range d, which are shown in FIG. 6).

When vanishing point 10 is not located below predetermined range b, then from the rearward image captured by imaging unit 5, image clipper 85c clips an image of a display target range obtained by moving down only the lower end of first display target range a.

Hereinafter, the display target range obtained by moving down the upper end and lower end of first display target range a or the display target range obtained by moving down only the lower end of first display target range a will be referred to as second display target range e.

In the example of FIG. 5, vanishing point 10 is located below predetermined range b in an upper portion of first display target range a. In this case, it is considered that no very important information is included in predetermined range b that is away from vanishing point 10. Therefore, image clipper 85c moves down the upper end of first display target range a, and excludes predetermined range b from the display target.

Specifically, in the case of moving down the upper end of the display target range, image clipper 85c moves the upper end within a range where vanishing point 10 is not excluded from second display target range e.

Moreover, a vertical length of range c in FIG. 6 is equal to the vertical length of first display target range a, and accordingly, a vertical length of second display target range e becomes longer than the vertical length of first display target range a by a vertical length of range d. Moreover, the vertical length of range d is set appropriately by the driver or the like.

In this way, for example, when following vehicle 9 has come near vehicle 1, an image including a wider range of a lower portion of following vehicle 9 than when following vehicle 9 has not come near vehicle 1 can be obtained, and information about a direction indicator and the like of following vehicle 9 can be presented to the driver.

When it is sensed by object sensor 85a that following vehicle 9 has come near vehicle 1 by sensing that following vehicle 9 is within the predetermined range behind vehicle 1, compressor 85d shown in FIG. 3 creates a compressed image obtained by compressing a part of the rearward image of vehicle 1 captured by imaging unit 5.

For example, compressor 85d creates, as the compressed image, an image (an image shown in FIG. 7) obtained by vertically compressing lower portion f of the rearward image in second display target range e. Here, a vertical length of range g shown in FIG. 7 is equal to the vertical length of first display target range a shown in FIG. 5.

For example, compressor 85d compresses lower portion f of the rearward image by using a bilinear method or a bicubic method. In this way, a size of vehicle 1 is reduced in the vertical direction, and accordingly, the information about the direction indicator and the like of following vehicle 9, which was not displayed before the compression, can be presented to the driver effectively.

Hence, it becomes easy for the driver to grasp the sense of distance between following vehicle 9 and a subject vehicle. Moreover, since a part of second display target range e is compressed, an uncompressed area remains in the compressed image. Hence, the driver can be prevented from erroneously recognizing a distance between following vehicle 9. In particular, in this exemplary embodiment, since lower portion f of second display target range e is compressed, a region including a vanishing point remains uncompressed. Hence, the above-described erroneous recognition of the distance can be prevented more effectively.

It is preferable that compressor 85d compress lower portion f of the rearward image so that a vertical length of lower portion f becomes two-thirds or more of the vertical length concerned before lower portion f is compressed. In this way, it can suppress a phenomenon that lower portion f of the rearward image becomes too small to be recognizable with ease.

Moreover, it is preferable that an area of an image in range h shown in FIG. 7 be not more than a half of an area of an image in range g. The area of the image to be compressed is limited as described above, and thus the driver can be suppressed from feeling that something is wrong.

Drawing unit 85e superimposes boundary line 11 (refer to FIG. 7), which indicates a boundary between a compressed region and an uncompressed region, on the compressed image. In this way, the driver can easily grasp which range is the compressed range.

Note that, though the boundary is indicated here by boundary line 11, the boundary may be indicated by another image such as an arrow in place of boundary line 11.

Controller 85f is connected to imaging unit 5, object sensor 85a, vanishing point calculator 85b, image clipper 85c, compressor 85d, drawing unit 85e, and display 82, and controls exchange of information between the respective units.

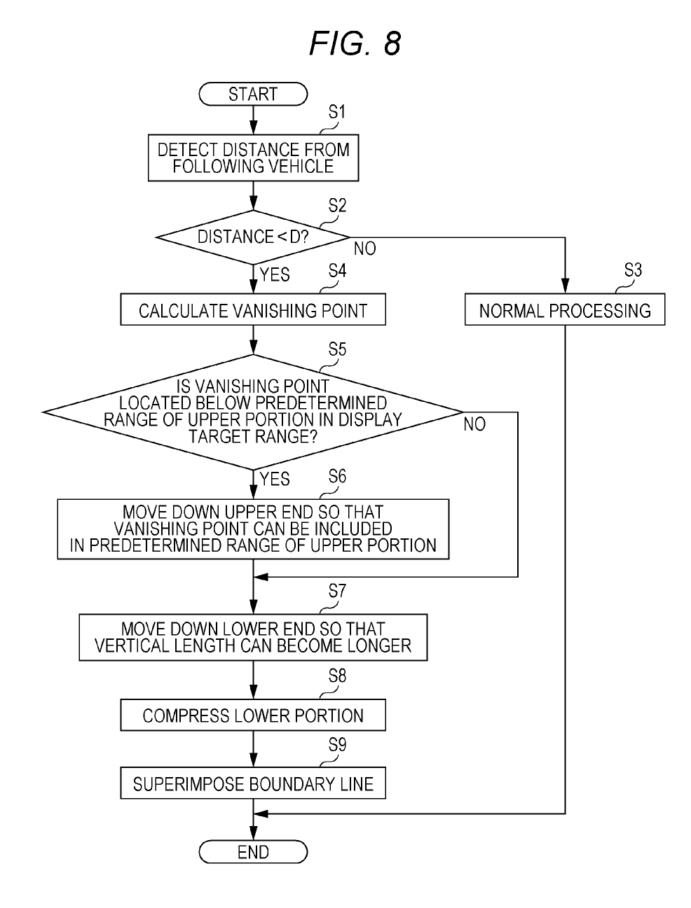

Next, a description will be made of an example of a processing procedure of image processing according to the first exemplary embodiment. FIG. 8 is a flowchart showing an example of the processing procedure of the image processing according to the first exemplary embodiment.

First, distance measuring sensor 6 detects the distance to following vehicle 9 (step S1). Then, object sensor 85a determines whether or not following vehicle 9 has come near vehicle 1 by sensing that vehicle 9 is within predetermined distance D behind vehicle 1, that is, whether or not the distance from vehicle 1 to following vehicle 9 is smaller than predetermined distance D (step S2).

When the distance from vehicle 1 to following vehicle 9 is not smaller than predetermined distance D (in the case of NO in step S2), image clipper 85c performs normal processing of clipping the image, which is captured by imaging unit 5, in first display target range a shown in FIG. 5, and outputting the clipped image (step S3), and then this image processing is ended. The image subjected to this image processing is displayed by display 82.

When the distance from vehicle 1 to following vehicle 9 is smaller than predetermined distance D (in the case of YES in step S2) in step S2, vanishing point calculator 85b calculates the position of vanishing point 10 of the image captured by imaging unit 5 (step S4).

Then, image clipper 85c determines whether or not vanishing point 10 is located below predetermined range b in the upper portion of first display target range a as shown in FIG. 5 (step S5).

When vanishing point 10 is located below predetermined range b (in the case of YES in step S5), image clipper 85c moves down the upper end of first display target range a so that vanishing point 10 is included in a predetermined range in the upper portion of the display target range (step S6). The upper end of second display target range e shown in FIG. 6 is determined as described above.

After the processing of step S6, or when vanishing point 10 is not located below predetermined range b (in the case of NO in step S5), image clipper 85c moves down the lower end of first display target range a so that the vertical length becomes longer than the vertical length of first display target range a shown in FIG. 5 (step S7). The lower end of second display target range e shown in FIG. 6 is determined as described above.

Then, compressor 85d compresses the lower portion of the image in the display target range, which is obtained by moving down the upper end and lower end of first display target range a, or in the display target range, which is obtained by moving down only the lower end of first display target range a (step S8). FIG. 7 shows the compressed image created by compressing the lower portion as described above.

Thereafter, drawing unit 85e superimposes boundary line 11 (refer to FIG. 7), which indicates the boundary between such a compressed region and such an uncompressed region, on the compressed image (step S9), and then this image processing is ended. The image subjected to this image processing is displayed by display 82.

As described above, in accordance with the first exemplary embodiment, it is made easy for the driver to grasp the sense of distance, and more information is presented to the driver when the driver confirms the rear, and thus a contribution can be made to the safe driving.

### Second Exemplary Embodiment

In the above-mentioned first exemplary embodiment, from the rearward image captured by imaging unit 5, image clipper 85c clips the image of the display target range, which is obtained by moving down the upper end and lower end of first display target range a, or the image of the display target range, which is obtained by moving down only the lower end of first display target range a.

In the second exemplary embodiment, a description will be made of the case of setting a capturing direction of imaging unit 5 to the downward direction in order to move down the upper end and lower end of the display target range.

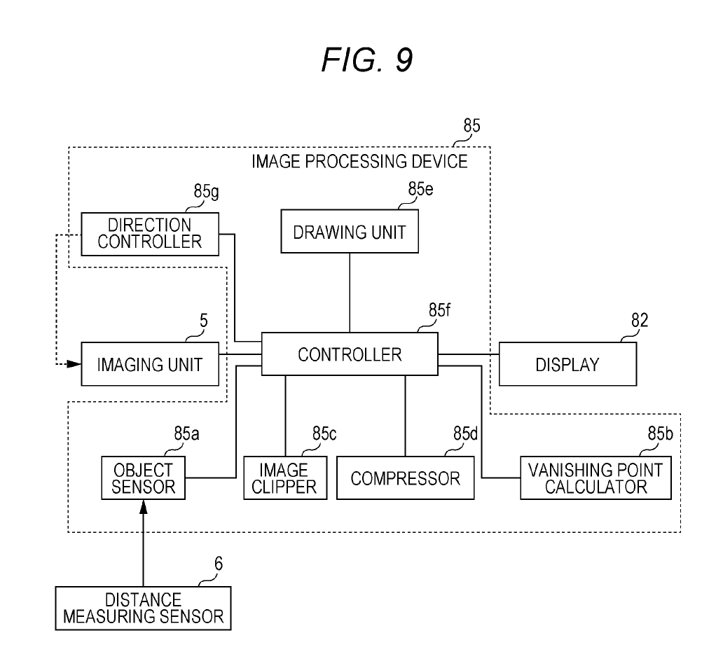

First, a description will be made of an example of a functional configuration of image processing device 85 according to the second exemplary embodiment. FIG. 9 is a block diagram showing an example of a functional configuration of image processing device 85 according to the second exemplary embodiment.

Unlike image processing device 85 shown in FIG. 3, image processing device 85 according to the second exemplary embodiment further includes direction controller 85g. Direction controller 85g controls the capturing direction of imaging unit 5.

Specifically, direction controller 85g controls a motor or the like (not shown), which changes the capturing direction of imaging unit 5, and moves down the upper end and lower end of the display target range.

In this way, the upper end and lower end of first display target range a shown in FIG. 5 can be moved down like range c shown in FIG. 6. Note that, in second display target range e in FIG. 6, the lower end is further moved down by the vertical length of range d, and this can be realized by setting a clipping range of the image in image clipper 85c wider in the downward direction.

Note that a method for changing the display target range from first display target range a to second display target range e is not limited to the above-described method. First, the capturing direction of imaging unit 5 may be changed until the lower end of first display target range a becomes the lower end of range d, and then, the clipping range of the image in image clipper 85c may be set wider in the upward direction until the upper end of the display target range becomes the upper end of second display target range e. That is, the change of the display target range from first display target range a to second display target range e just needs to be performed by both of the change of the capturing direction of imaging unit 5 and the change of the clipping range of the image in image clipper 85c.

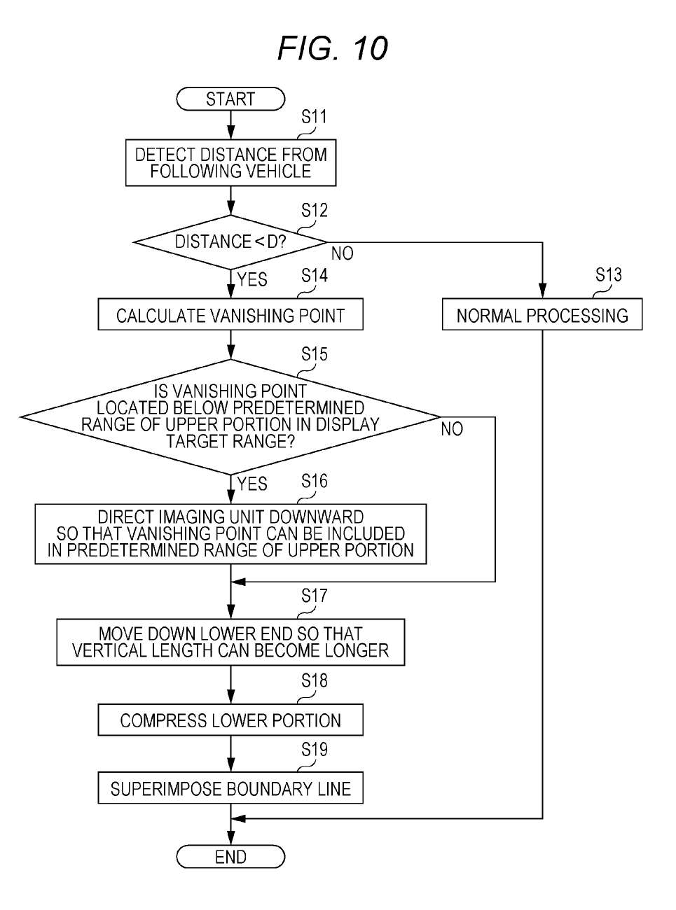

Next, a description will be made of an example of a processing procedure of image processing according to the second exemplary embodiment. FIG. 10 is a flowchart showing an example of the processing procedure of the image processing according to the second exemplary embodiment.

Here, processing in steps S11 to S15 and steps S17 to S19 is the same as the processing in steps S1 to S5 and steps S7 to S9, which are shown in FIG. 8, respectively.

However, in this image processing, in step S16, direction controller 85g directs the capturing direction of imaging unit 5 downward in order to move down the upper end of first display target range a shown in FIG. 5 so that vanishing point 10 can be included in the predetermined range in the upper portion of the display target range. In this way, as in the example shown in FIG. 6, the upper end and lower end of range c can be determined.

As described above, in accordance with the second exemplary embodiment, the capturing direction of imaging unit 5 is adjusted, and thus the display target range in the image captured by imaging unit 5 can be determined easily.

### Third Exemplary Embodiment

In the above-mentioned first and second exemplary embodiments, compressor 85d compresses the lower portion of the image in the display target range; however, it may compress the upper portion of the image in the display target range. Accordingly, in the third exemplary embodiment, a description will be made of the case where compressor 85d compresses the upper portion of the image in the display target range.

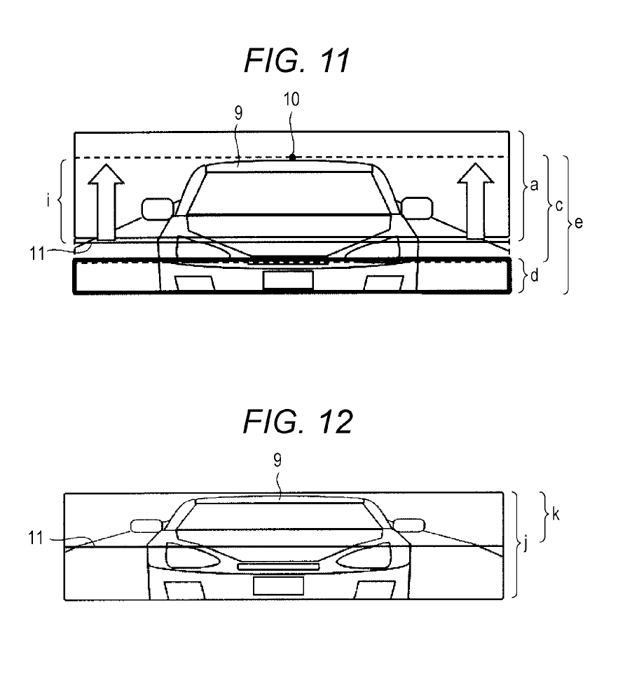

FIG. 11 is a diagram showing an example of the image processing performed on the rearward image captured by imaging unit 5. FIG. 12 is a diagram showing an example of a display image obtained as a result of the image processing.

Note that a functional configuration of image processing device 85 in this exemplary embodiment is the same as the functional configuration shown in FIG. 3 except for compressor 85d.

In this exemplary embodiment, in a similar way to the first exemplary embodiment, from the rearward image captured by imaging unit 5, image clipper 85c clips an image of a display target range (a range obtained by combining range c and range d, which are shown in FIG. 11), which is obtained by moving down an upper end and lower end of first display target range a shown in FIG. 5.

Also in this case, in a similar way to the case shown in FIG. 6, second display target range e is a display target range obtained by moving down the upper end and lower end of first display target range a or the display target range obtained by moving down only the lower end of first display target range a.

Here, a vertical length of range c in FIG. 11 is equal to the vertical length of first display target range a shown in FIG. 5, and accordingly, a vertical length of second display target range e becomes longer than the vertical length of first display target range a by the vertical length of range d.

Then, compressor 85d creates, as the compressed image, an image (an image shown in FIG. 12) obtained by vertically compressing upper portion i of the rearward image, which is present in second display target range e. Here, a vertical length of range j shown in FIG. 12 is equal to the vertical length of first display target range a shown in FIG. 5.

Moreover, it is preferable that an area of an image in range k shown in FIG. 12 be a half or less of an area of an image in range j. The area of the image to be compressed is limited as described above, and thus the driver can be suppressed from feeling that something is wrong.

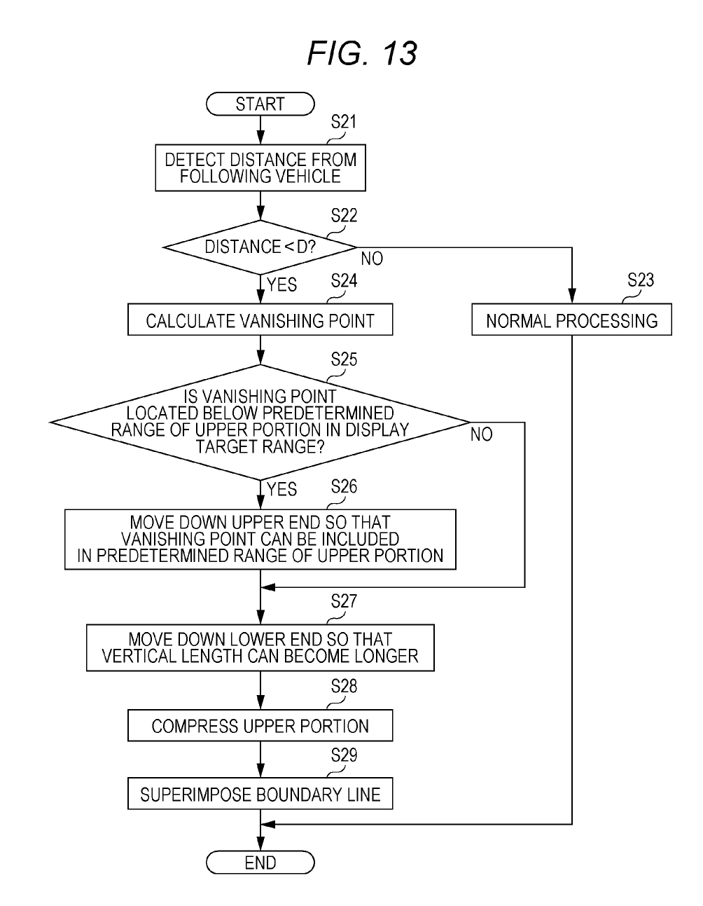

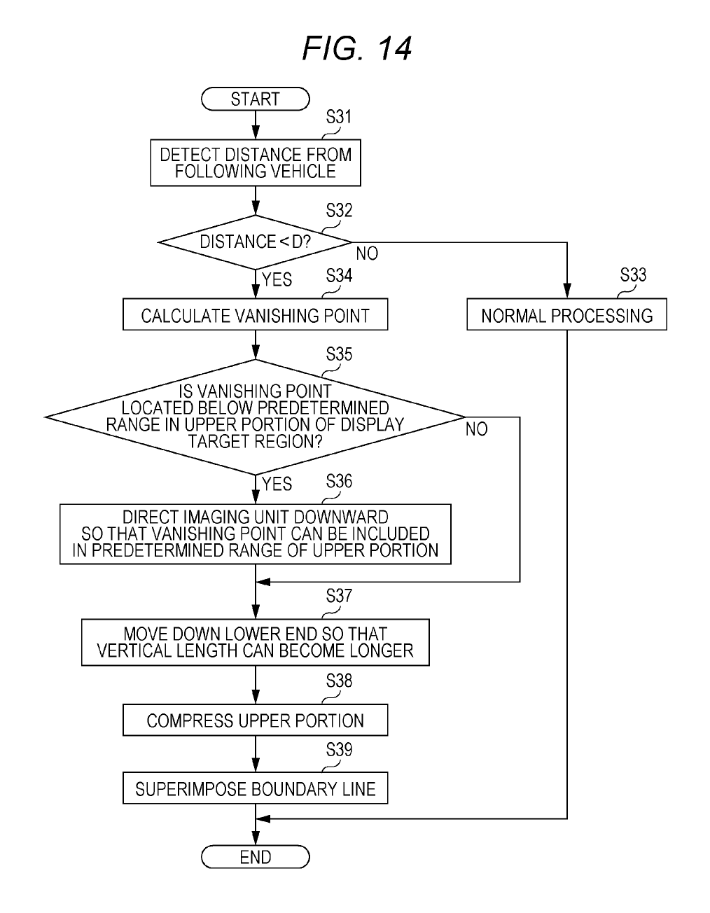

Next, a description will be made of an example of a processing procedure of image processing according to the third exemplary embodiment. FIG. 13 is a flowchart showing an example of the processing procedure of the image processing according to the third exemplary embodiment.

Here, processing in steps S21 to S27 and step S29 is the same as the processing in steps S1 to S7 and step S9, which are shown in FIG. 8, respectively.

However, in this exemplary embodiment, in step S28, compressor 85d compresses the upper portion of the image in the display target range, which is obtained by moving down the upper end and lower end of first display target range a, or in the display target range, which is obtained by moving down only the lower end of first display target range a, as described with reference to FIG. 11.

FIG. 12 shows a compressed image, which is created in such a manner that the upper portion is compressed as described above, and has boundary line 11 superimposed on the compressed image by drawing unit 85e, boundary line 11 indicating the boundary between the compressed region and the uncompressed region.

As described above, in accordance with the third exemplary embodiment, it is made easy for the driver to grasp the sense of distance, and more information is presented to the driver when the driver confirms the rear, and thus a contribution can be made to the safe driving. Moreover, the upper portion of the image in the display target range is compressed, and the lower portion of the image is not compressed, so that the image of the lower portion of the vehicle can be made easy to see.

### Fourth Exemplary Embodiment

In the above third exemplary embodiment, in a similar way to the first exemplary embodiment, from the rearward image captured by imaging unit 5, image clipper 85c clips the image of the display target range, which is obtained by moving down the upper end and lower end of first display target range a, or the image of the display target range, which is obtained by moving down only the lower end of first display target range a.

In the fourth exemplary embodiment, a description will be made of the case of setting the capturing direction of imaging unit 5 to the downward direction in order to move down the upper end and lower end of the display target range. Here, a functional configuration of image processing device 85 according to the fourth exemplary embodiment is the same as the functional configuration of image processing device 85 according to the second exemplary embodiment described with reference to FIG. 9.

Specifically, direction controller 85g in this exemplary embodiment controls a motor or the like (not shown), which changes the capturing direction of imaging unit 5, and moves down the upper end and lower end of the display target range.

In this way, the upper end and lower end of first display target range a shown in FIG. 5 can be moved down like range c shown in FIG. 6. Note that, in second display target range e in FIG. 6, the lower end is further moved down by the vertical length of range d, and this can be realized by setting a clipping range of the image in image clipper 85c wider in the downward direction.

Note that a method for changing the display target range from first display target range a to second display target range e is not limited to the above-described method. First, the capturing direction of imaging unit 5 may be changed until the lower end of first display target range a becomes the lower end of range d, and then, the clipping range of the image in image clipper 85c may be set wider in the upward direction until the upper end of the display target range becomes the upper end of second display target range e. That is, the change of the display target range from first display target range a to second display target range e just needs to be performed by both of the change of the capturing direction of imaging unit 5 and the change of the clipping range of the image in image clipper 85c.

Next, a description will be made of an example of a processing procedure of image processing according to this fourth exemplary embodiment. FIG. 14 is a flowchart showing an example of the processing procedure of the image processing according to this fourth exemplary embodiment.

Here, processing in steps S31 to S37 and step S39 is the same as the processing in steps S11 to S17 and step S19, which are shown in FIG. 10, respectively.

However, in this exemplary embodiment, in step S38, compressor 85d compresses the upper portion of the image in the display target range, which is obtained by moving down the upper end and lower end of first display target range a, or in the display target range, which is obtained by moving down only the lower end of first display target range a, as described with reference to FIG. 11. By such image processing as described above, a compressed image similar to the image shown in FIG. 12 can be obtained.

As described above, in accordance with the fourth exemplary embodiment, it is made easy for the driver to grasp the sense of distance, and more information is presented to the driver when the driver confirms the rear, and thus a contribution can be made to the safe driving. Moreover, the upper portion of the image in the display target range is compressed, and the lower portion of the image is not compressed, so that the image of the lower portion of the vehicle can be made easy to see.

Moreover, the capturing direction of imaging unit 5 is adjusted, so that the display target range in the image captured by imaging unit 5 can be determined easily.

Note that, in each of the first to fourth exemplary embodiments, compressor 85d compresses the lower portion or upper portion of the image in the display target range, which is obtained by moving down the upper end and lower end of the original display target range, or in the display target range, which is obtained by moving down only the lower end; however, may compress only a center portion of the display target range, and does not have to compress the lower portion or upper portion of the image.

### INDUSTRIAL APPLICABILITY

The image processing device and the electronic mirror system according to the present invention are suitable for application to the image processing device, which performs the image processing for the rearward image of the vehicle, the rearward image being captured by the imaging unit, and outputs the image to the display, the image being obtained as a result of the image processing, and application to the electronic mirror system including the image processing device.

### REFERENCE MARKS IN THE DRAWINGS

1 vehicle
2 inside
3 front seat
4 rear seat
5 imaging unit
6 distance measuring sensor
7 attachment portion
8 image display device
9 following vehicle
10 vanishing point
11 boundary line
81 main body case
82 display
83 light control filter
84 operating portion
85 image processing device
85a object sensor
85b vanishing point calculator
85c image clipper
85d compressor
85e drawing unit
85f controller
85g direction controller

1. An image processing device that performs image processing on a rearward image of a vehicle and outputs an image to a display, the rearward image being captured by an imaging unit, the image being obtained as a result of the image processing, the image processing device comprising:
an object sensor that senses that an object has come near the vehicle by sensing that the object is within a predetermined range behind the vehicle; and
a compressor that creates a compressed image obtained by compressing a part of a display target range in the rearward image when the object sensor senses that the object has come near the vehicle by sensing that the object is within the predetermined range behind the vehicle,
wherein, when the object having come near is sensed, the display target range is changed to a second display target range obtained by moving down a lower end of a first display target range, the first display target range being the display target range when the object is out of the predetermined range, and
the compressor compresses a part of the rearward image in a vertical direction, the rearward image being present within the second display target range.

2. The image processing device according to claim 1, wherein the second display target range is a range obtained by moving down an upper end of the first display target range, and a vertical length of the second display target range is longer than a vertical length of the first display target range.

3. The image processing device according to claim 2, further comprising a vanishing point calculator that calculates a position of a vanishing point of the rearward image, wherein the vanishing point is included in the second display target range.

4. The image processing device according to claim 1, further comprising a drawing unit that superimposes, on the compressed image, an image indicating a boundary between a compressed region and an uncompressed region.

5. The image processing device according to claim 1, further comprising an image clipper that clips a part of the rearward image as the display target range, wherein the movement of the lower end of the first display target range is performed by causing the image clipper to move down a clipping range.

6. The image processing device according to claim 1, further comprising a direction controller that controls a capturing direction of the imaging unit, wherein the movement of the lower end of the first display target range is performed by controlling the capturing direction.

7. The image processing device according to claim 1, wherein the predetermined range is a range where a distance from a rear end of the vehicle stays within a distance corresponding to a horizontal distance from the rear end of the vehicle to a mounting position of the display.

8. The image processing device according to claim 1, wherein the compressor compresses a part of the rearward image in the vertical direction so that a vertical length of a part of the rearward image becomes two-thirds or more of the vertical length before the part is compressed.

9. The image processing device according to claim 1, wherein an area of an image in a range compressed in the image obtained as a result of the image processing is a half or less of an area of the image obtained as a result of the image processing.

10. The image processing device according to claim 1, wherein the compressor compresses, in the vertical direction, a lower portion of the rearward image in the second display target range.

11. The image processing device according to claim 1, wherein the compressor compresses, in the vertical direction, an upper portion of the rearward image in the second display target range.

12. An electronic mirror system comprising: the image processing device according to claim 1; the display; the imaging unit; and a distance measuring sensor that outputs a signal indicating a distance between the vehicle and the object, wherein the object sensor senses that the object has come near the vehicle by sensing that the object is within the predetermined range behind the vehicle based on the signal output from the distance measuring sensor.

13. The image processing device according to claim 5, further comprising a direction controller that controls a capturing direction of the imaging unit, wherein the movement of the lower end of the first display target range is performed by controlling the capturing direction.
